(19) United States
(12) Patent Application Publication
(10) Pub. No.: US 2024/0287634 A1
(43) Pub. Date: Aug. 29, 2024

(54) METHOD FOR PRODUCING AN OXIDATION PROTECTION COATING AT LEAST IN REGIONS ON A COMPONENT OF A THERMAL GAS TURBINE

(71) Applicant: MTU Aero Engines AG, München (DE)

(72) Inventors: Nils Weidlich, Neustadt (DE); Frank Seidel, Grossburgwedel (DE); Ezgi Schoening, Hannover (DE)

(73) Assignee: MTU Aero Engines AG, München (DE)

(21) Appl. No.: 18/581,584

(22) Filed: Feb. 20, 2024

(30) Foreign Application Priority Data
Feb. 24, 2023 (DE) 10 2023 104 545.8

(51) Int. Cl. C21D 1/72; B05D 3/04; B05D 3/06; B05D 7/16; C21D 1/26; C21D 1/74

(52) U.S. Cl. CPC C21D 1/72; B05D 3/0473; B05D 3/067; B05D 7/16; C21D 1/26; C21D 1/74; B05D 2601/28

(57) ABSTRACT

The invention relates to a method for producing at least in regions an oxidation protection coating on a component of a thermal gas turbine. In accordance with the invention, the method comprises the steps of coating the component at least in regions with a lacquer, which comprises at least one UV-curable binder and metal particles, curing the lacquer by exposure to UV light, and thermal treatment of the component at least in the region of the cured lacquer for production of the oxidation protection coating.

### BACKGROUND OF THE INVENTION

The invention relates to a method for producing an oxidation protection coating at least in regions on a component of a thermal gas turbine.

Many engine components of thermal gas turbines are exposed to high temperatures and pressures during operation. Therefore, they are provided with an oxidation protection coating, which is produced at least in regions on the surface of the respective component or on the entire surface of the component. During the maintenance and repair of such components, it is often necessary to remove locally or completely the oxidation coating on damaged regions. In order to further guarantee an adequate protection of the base material of the component, it is necessary to restore the oxidation protection coating on these regions before conclusion of the repair (“touch-up coating”). Typically, thermally cured slurries containing metal particles as filler are thereby used for local coating. The slurry is applied in a plurality of layers onto the corresponding region of the component with respective intervening drying steps. The intervening drying steps are thereby relevant in order to be able to attain step by step the desired minimum coating thickness of the oxidation protection coating on the component. For attaining an adequate coating thickness, up to four or more layers of slurry are often required, because the stable thickness of the slurry layers is limited to approximately 20 μm or less. In a subsequent thermal treatment, the metal particles diffuse into the component base material serving as substrate and form the protective oxidation protection coating.

A problem in the method used hitherto is that the coating of the component with the slurry by the requisite number of layers is very tedious, prone to error, and strongly limited in its maximally attainable coating thickness, because each additional layer affords ever less increase in coating thickness. Therefore, the required rate of rework is in part high.

### SUMMARY OF THE INVENTION

The object of the present invention is to create a simpler, faster, and less error-prone method for producing an oxidation protection coating at least in regions on a component of a thermal gas turbine.

The object is achieved in accordance a method of the present invention. Advantageous embodiments with appropriate further developments of the invention are discussed in detail below.

A first aspect of the invention relates to a method for producing an oxidation protection coating at least in regions on a component of a thermal gas turbine. In accordance with the invention, the method comprises at least the steps of coating at least regions of the component with a lacquer, which comprises at least one UV-curable binder and metal particles, curing the lacquer by exposure to UV light, and thermal treatment of the component at least in the region of the cured lacquer for producing the oxidation protection coating. In other words, it is provided in accordance with the invention that, instead of the presently used thermally cured slurries, a UV-curable lacquer is used for partial or complete coating of the component, which, after curing of the lacquer, is subjected to a thermal treatment by exposure to UV light in order to form the final oxidation protection coating. The method according to the invention can be carried out more simply, faster, and in a less error-prone manner, because, through the use of the UV-curable lacquer, overall greater coating thicknesses and accordingly higher coating qualities of the final oxidation protection coating can be attained in fewer application steps and without the need for intervening drying steps. In general, “a/an” in the scope of this disclosure is to be read as an indefinite article, that is, unless explicitly stated otherwise, always also as “at least one.” Conversely, “a/an” can also be understood to mean “only one.”

In an advantageous embodiment of the invention, it is provided that, for coating, a lacquer that comprises, in addition, at least one solvent and/or one additive and/or one filler and/or one photoinitiator is used. In this way, it is possible for the physical and chemical properties of the lacquer to be adjusted optimally to the respective intended use. The viscosity and workability of the lacquer can be influenced advantageously by the selection and the weight proportion of the solvent. The selection of a photoinitiator as additive ensures the reliable initiation of a polymerization of the binder by UV radiation. The lacquer is hereby cured by the formation of cross-links within the binder. With the aid of one filler or a plurality of fillers, it is possible to influence the application properties of the lacquer as well as the properties of the later oxidation protection coating and to adjust them likewise optimally to the respective intended use. Alternatively or additionally, it can be provided that a binder comprising at least one oligomer and/or at least one prepolymer is used. To be mentioned here by way of example, are, in particular, UV-curable resins and/or (meth)acrylate compounds, which are especially well suited as binders for the lacquer of the present method.

In a further advantageous embodiment of the invention, it is provided that the lacquer is applied onto the component a spraying device and/or by a brush. This represents a flexible, simple, and low-cost possibility for local coating of the component. Alternatively or additionally, it is provided that the lacquer is applied onto the component with a coating thickness of between 50 μm and 250 μm, in particular between 70 μm and 200 μm. In this way, a coating thickness that ensures the subsequent formation of an especially reliable oxidation protection coating is attained. Preferably, it is provided in a further embodiment that only a single layer of the lacquer is applied onto the component. The lacquer used in the scope of the method according to the invention makes it possible, in contrast to prior art, to ensure an adequate coating thickness with the application of a single layer. In this way, it is possible to realize substantial advantages in terms of time and cost and to reduce substantially the rework rates.

In a further advantageous embodiment of the invention, a lacquer that, at a temperature of between 5° C. and 30° C., has a dynamic viscosity of between 1000 mPa*s and 2000 mPa*s is used. In this way, an especially good workability of the lacquer in the scope of the method according to the invention is ensured, because, on the one hand, the lacquer is not too runny and, on the other hand, it is also not too viscous for application. The viscosity of the lacquer can be measured using a viscometer in accordance with EN ISO 3219, for example.

Further advantages ensue in that, as metal particles, aluminum particles are used and/or in that a weight proportion of the metal particles in the total weight of the lacquer lies between 20 wt % and 70 wt % and/or in that the metal particles have a mean particle size of up to 1 μm. In this way, it is possible to produce especially reliable oxidation protection coatings with high coating quality. The determination of the mean particle size is based on the diameter in the case of round metal particles and the volume-equivalent spherical diameter of the metal particles in the case of non-circular or irregularly shaped particles.

An especially fast and reliable curing of the lacquer is ensured in a further embodiment of the invention in that, for curing, the lacquer is exposed to UV light with a wavelength of between 200 nm and 400 nm, preferably in the region between 350 and 380 nm.

Further advantages ensue in that the thermal treatment comprises a diffusion annealing process for the formation of the oxidation protection coating. By a diffusion annealing process, which is also referred to as solution annealing, homogenization, or stress-relief annealing, it is possible for the binder of the lacquer, which initially holds the metal particles together after the application of the lacquer, to undergo decomposition and combustion (debinding). The remaining metal particles are distributed homogeneously on the surface of the component, diffuse in part into the component, and form the oxidation protection coating.

In a further embodiment, it has hereby been found to be advantageous when the diffusion annealing process comprises an annealing of the component at a temperature of between 800° C. and 1000° C. and/or when the diffusion annealing process is carried out at least for one hour and preferably for several hours and/or when the diffusion annealing process is carried out under an atmosphere of protective gas, in particular, under argon atmosphere. In this way, an especially high and reliable protective effect of the oxidation protection coating is achieved.

In a further embodiment of the invention, it is provided that the produced oxidation protection coating comprises at least one diffusion layer and one buildup layer. In other words, the oxidation protection coating can comprise two or more layers or zones, namely, in particular, a diffusion layer and a buildup or cover layer. The structure of the diffusion layer or zone as well as of the buildup layer or zone is governed, in general, by the base material of the component, by the material of the metal particles used, and by the duration and temperature of the thermal treatment process.

Further advantages ensue in that the method according to the invention is carried out in the scope of a manufacture, maintenance, and/or repair of the component. In other words, the method according to the invention can be used not only in the scope of a repair of the component, but also during a maintenance and even during the first manufacture of the component for producing the oxidation protection coating.

### BRIEF DESCRIPTION OF THE DRAWING FIGURES

Further features of the invention ensue from the claims, the figures, and the descriptions of the figures. The features and combinations of features mentioned above in the description as well as the features and combinations of features mentioned below in the description of the figures and/or shown in the figures alone can be used not only in the respectively specified combination, but also in other combinations without leaving the scope of the invention. Accordingly, embodiments that are not explicitly shown and explained in the figures, but ensue from and can be produced from the explained embodiments by separate combinations of features, are also to be regarded as comprised and disclosed. Accordingly, embodiments and combinations of features that do not have all features of an independent claim as originally formulated are also to be regarded as disclosed. Beyond this, embodiments and combinations of features, in particular through the embodiments described above, that go beyond the combinations of features presented with reference to the claims or depart from them are also to be regarded as disclosed. Hereby shown are:

FIG. 1 a schematic illustration of a method known from prior art for producing an oxidation protection coating on a component of a thermal gas turbine; and

FIG. 2 a schematic illustration of a method according to the invention for producing an oxidation protection coating on a component of a thermal gas turbine.

### DESCRIPTION OF THE INVENTION

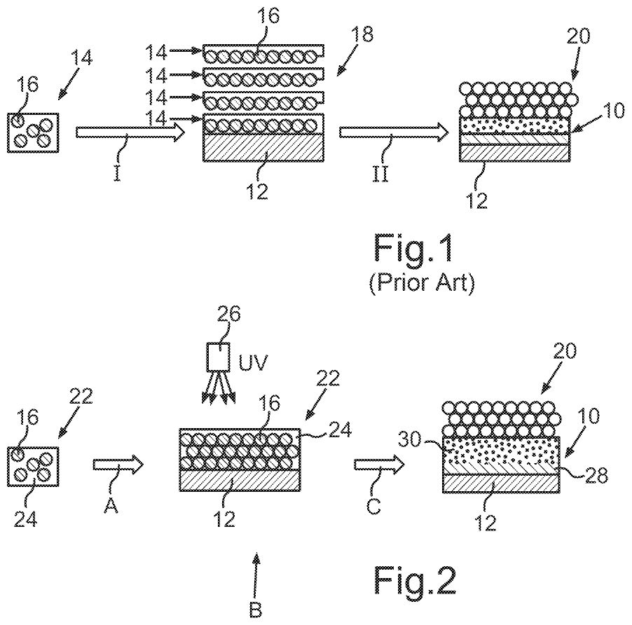

FIG. 1 shows a schematic illustration of a method known from prior art for producing an oxidation protection coating 10 on a component 12 of a thermal gas turbine (not depicted). The component 12 can be an engine component or a gas turbine component, such as, for example, an airfoil. A so-called “touch-up coating” has been employed up to now for the local coating of such engine components and gas turbine components. It is based on a thermally cured slurry 14, which contains metal particles 16 and, in step I, is applied locally in a plurality of layers 18 onto the component 12 in question, whereby, after the application of each layer 18, an intervening drying step occurs. For attaining an adequate coating thickness in this process, often four or more layers 18 of the slurry 14 with corresponding intervening drying steps are required, because the stable thickness of the slurry layers 18 is limited to about 20 μm or less. Once the desired coating thickness has been attained, there follows, in step II, a thermal treatment, in which the oxidation protection coating 10 is produced on the component 12 serving as substrate. As a rule, so-called “empty oxide shells” 20, which involve slurry residues or material residues that, after the thermal treatment, are left behind on the oxidation protection coating, remain on the oxidation protection coating 10 and, for example, can be removed by irradiation or the like. This known coating process is very tedious, error-prone, and limited in terms of its final coating thickness owing to the requisite number of layers 18, because each additional layer 18 affords ever less coating thickness. In addition, the rework rate for the slurries 14 employed at present lies at up to 40%.

FIG. 2 shows a schematic illustration of a method according to the invention for producing an oxidation protection coating 10 on a component 12 of a thermal gas turbine. In contrast to the method shown in FIG. 1, a lacquer 22 is used here and comprises a UV-curable organic binder 24, in which the metal particles 16, which, in the example shown, are aluminum particles, are present in dispersion. The binder 24 can hereby consist of an oligomer or of a prepolymer, such as, for example, a resin and/or a (meth)acrylate compound. Optionally, the lacquer 22 can contain further components, such as solvents, additives, fillers, and/or photoinitiators, either alone or in any combination. The lacquer 22 has a dynamic viscosity of between 1000 mPa*s and 2000 mPa*s at 15° C. to 30° C. and can be applied in step A onto a local region of the component 12 by spraying (for example, spray coating) and/or lacquering (for example, using a brush). For example, this can occur in the scope of a repair of the component 12. The coating thickness hereby attainable in a single pass is usually between 70 μm and 200 μm or more, so that, as a rule, it is sufficient to apply a single layer 18. Accordingly, it is possible to dispense entirely with intervening drying steps. The weight proportion of the metal particles 16 in the total weight of the lacquer 22, depending on use, lies between about 20 wt % and about 70 wt %. The mean particle size of the metal particles 16 is preferably up to 1 μm.

After the application, the lacquer 22 or its binder 24 is cured in step B. This occurs by exposure of the lacquer 22 to UV irradiation. The wavelength of the UV irradiation for the cross-linking lies between 200 nm and 400 nm and, in particular, at about 365 nm. To this end, it is possible to use a corresponding UV irradiation device 26. The provision of a photoinitiator in the lacquer 22 hereby makes possible the initiation of a polymerization reaction by the UV irradiation. Owing to the formation of cross-links within the binder, the lacquer 22 is then cured.

In the next step C, there occurs a diffusion annealing as thermal treatment for the formation of the oxidation protection coating 10. To this end, the diffusion annealing is carried out at a temperature of between 800° C. and 1000° C. for one hour or several hours under an atmosphere of protective gas (argon). In the process, aluminum diffuses into the base material of the component 12 and forms a diffusion layer 28 as well as a buildup layer or cover layer 30. Here, too, empty oxide shells 20 may remain on the oxidation protection coating 10 and can be removed by irradiation or the like, for example.

The parameter values specified in the documentation for defining the process and measurement conditions for the characterization of specific properties of the subject of the invention are also to be regarded in terms of deviations—for example, on account of measurement errors, system errors, weighing errors, DIN tolerances, or the like-as being included in the scope of the present invention.

What is claimed is:

1. A method for producing an oxidation protection coating at least in regions on a component of a thermal gas turbine, comprising the steps of:
coating of the component at least in regions with a lacquer, which comprises at least one UV-curable binder and metal particles;
curing of the lacquer by exposure to UV light; and
thermally treating the component at least in the region of the cured lacquer for production of the oxidation protection coating.

2. The method according to claim 1, wherein a lacquer, in addition, comprises at least one solvent and/or one additive and/or one filler and/or one photoinitiator is used for the coating, and/or wherein a binder comprises at least one oligomer and/or at least one prepolymer is used.

3. The method according to claim 1, wherein the lacquer is applied onto the component by a spraying device and/or by a brush, and/or wherein the lacquer is applied onto the component with a coating thickness of between 70 μm and 200 μm, and/or wherein only a single layer of the lacquer is applied onto the component.

4. The method according to claim 1, wherein a lacquer that, at a temperature of between 5° C. and 30° C., has a dynamic viscosity of between 1000 mPa*s and 2000 mPa*s is used.

5. The method according to claim 1, wherein, as metal particles aluminum particles are used, and/or wherein a weight proportion of the metal particles in the total weight of the lacquer lies between 20 wt % and 70 wt %, and/or wherein the metal particles have a mean particle size of up to 1 μm.

6. The method according to claim 1, wherein the lacquer is exposed to UV light with a wavelength of between 200 nm and 400 nm for curing.

7. The method according to claim 1, wherein the step of thermally treating comprises a diffusion annealing process for forming the oxidation protection coating.

8. The method according to claim 7, wherein the diffusion annealing process comprises an annealing of the component at a temperature of between 800° C. and 1000° C., and/or wherein the diffusion annealing process is carried out at least for one hour and preferably for several hours, and/or in that the diffusion annealing process is carried out under an atmosphere of argon atmosphere.

9. The method according to claim 1, wherein the produced oxidation protection coating comprises at least one diffusion layer and one buildup layer.

10. The method according to claim 1, wherein the method is for the manufacture, maintenance, and/or a repair of the component.
